(19) United States
(12) Patent Application Publication
(10) Pub. No.: US 2008/0156899 A1
(43) Pub. Date: Jul. 3, 2008

(54) Slurry Installation Method and Apparatus

(75) Inventor: Ronald G. McKew, Booral New South Wales (AU)

Correspondence Address: WHITHAM, CURTIS & CHRISTOFFERSON & COOK, P.C., 11491 SUNSET HILLS ROAD, SUITE 340, RESTON, VA, 20190, US

(73) Assignee: SHINAGAWA REFRACTORIES AUSTRALASIA PTY LTD, Unanderra (AU)

(21) Appl. No.: 10/593,024

(22) PCT Filed: Mar. 31, 2005
(86) PCT No.: PCT/AU05/00470

§ 371 Date: Jan. 23, 2008

(30) Foreign Application Priority Data
Apr. 5, 2004 (AU) 2004901815

(51) Int. Cl. F27D 1/16; B05B 7/14; B05B 7/04; B28C 7/16; B28C 5/06

(52) U.S. Cl. 239/142; 366/341; 239/398

(57) ABSTRACT

The present invention provides a slurry spraying or installation system (10) including a gun means (12), a spray nozzle (17) and a conduit (16) connecting said gun means (12) to said spray nozzle (17), said gun means (12) including a pump means to move dry particulate towards said nozzle along said conduit (16), wherein between said gun means (12) and said nozzle (17) is a mixing device (20) which receives said dry particulate and mixes same with liquid under a greater pressure than the pressure that said dry particulate is under, so as to form a liquid and dry particulate mixture; said mixture being fed to said nozzle (17) for dispensing to a target.

### FIELD OF THE INVENTION

The present invention relates to installation systems and devices for applying and forming settable slurries such as refractory linings, insulation, concrete, cement and similar products.

### BACKGROUND OF THE INVENTION

Conventional methods of application of refractory linings to furnace walls by gunning techniques result in a relatively large amount of product which contacts the target area and rebounds therefrom. This rebounded refractory material or slurry can deposit itself into the recently sprayed portion or onto the furnace floor. This rebound can comprise up to 10% to 15% of the effective or useful product actually sprayed onto the furnace surface. This 10% to 15% represents a relatively large amount of wastage and at the cost of it is valuable and thus undesirable.

### SUMMARY OF THE INVENTION

The present invention provides a slurry spraying or installation system including a gun means, a spray nozzle and a conduit connecting said gun means to said spray nozzle, said gun means including a pump means to move dry particulate towards said nozzle along said conduit, wherein between said gun means and said nozzle is a mixing device which receives said dry particulate and mixes same with liquid under a greater pressure than the pressure that said dry particulate is under, so as to form a liquid and dry particulate mixture; said mixture being fed to said nozzle for dispensing to a target.

The mixing device can include an expansion chamber having a diverging passage which diverges in the direction of flow of said dry particulate.

The mixing device can include, downstream of said diverging passage, a transition passage which can have a substantially constant cross section or can be of a converging shape.

At least one of said diverging passage or said transition passage, or at a location between these passages, there can be included a liquid inlet.

The liquid inlet can include a liquid inlet nozzle which projects liquid from said nozzle at an angle to the direction of flow of said dry particulate through said mixing device. The liquid inlet nozzle can be at an angle of between 40° and 80° from the direction of flow.

The nozzle can be aligned so that a central longitudinal axis thereof intersects a central longitudinal axis of said mixing device. Alternatively the nozzle can be aligned so that a central longitudinal axis thereof is skewed relative to a central longitudinal axis of said mixing device.

The mixing device can include a converging passage downstream of said transition passage.

Preferably the inlet to the diverging passage has is of a larger cross sectional area than the cross sectional area of the end of the conduit delivering said dry particulate from said gun means to said mixing device.

The inlet to the diverging passage can have a diameter in the range from 5% to 200% larger than the internal diameter of the conduit delivering dry particulate to said diverging passage. Preferably, the conduit has an internal diameter of approximately 38 mm and said inlet diameter of said diverging passage is in the range of 40 to 60 mm and possibly up to 80 mm.

Preferably, the inside diameter of said diverging passage at the end of said passage is of the order of 55 mm to 80 mm. A preferred set of dimensions include: the inlet is 50 mm and the end of the passage expands out to 65 mm for a 38 mm inside diameter conduit delivering dry particulate to said diverging passage.

The diverging passage can be of a length which varies from 150 to 900 mm.

The transition passage can have the same cross sectional area or internal diameter as the outlet end of the diverging passage. Preferably, the transition passage extends for a distance of between 100 and 300 mm.

The converging passage can terminate in an outlet passage of substantially constant cross section. The outlet can have a cross sectional area which is approximately equal to the cross sectional area of the passage in a conduit to be connected to said outlet. The outlet can have an internal diameter which is approximately equal to the internal diameter of a conduit to be connected to said outlet.

The converging passage can vary between of the order of 60 mm to 80 mm at its larger diameter and tapers down to 38 mm on its outlet diameter. The length of the taper can vary between 350 mm and 1500 mm. The length of taper or converging can be of the order of 600 mm to 800 mm but most preferably around 720 mm.

The diverging portion can end in an outlet passage which is of substantially constant cross section which can extend for between 80 mm and 200 mm and more preferably 120 mm.

The liquid inlet can be a liquid ring, however, most preferably, for the purposes of refractory and or concrete systems the liquid inlet is a nozzle. The nozzles preferred are those manufactured by Spray Systems Company Pty Ltd, as detailed below.

In respect of a system whereby the gun means the nozzle during use and the mixing device are within a height differential of between up to 1 metre to 2 metres of each other, the mixing device is to be located along a conduit length of no more than 90 metres from the nozzle. The mixing device can be in the range of 5 m to 15 m from the gun means. Illustrated in FIG. 10 is a schematic showing the expected height and conduit length limitations. These limitations will be described in more detail below.

The gun means preferably applies a pressure of between 100 kPa and 600 kPa to the dry particulate.

The liquid inlet to the mixing device can have its own supply and pressure source.

The pressure source can supply liquid to the liquid inlet at approximately 1000 kPa. Alternatively, the pressure source can supply enough pressure to provide a pressure differential between the liquid inlet pressure and the dry particulate pressure of the order of 200 kPa to 900 kpa.

Preferably the liquid inlet nozzle propels liquid in a spray stream, wherein the range of spray angle for the jet emitted therefrom is of the order of 70° to 120° with a flow rate of between 0.1 US gallon per minute to 0.4 US gallons per minute.

Preferably the system develops a pressure of the order of 100 kPa to 200 kPa, when measured at approximately 1 metre to 2 metres back from the nozzle.

Preferably said system includes the ability to add liquid to said slurry at said nozzle prior to ejection or emission from said nozzle.

Present invention also provides a mixing device to preform a settable slurry, said device including an inlet having a larger internal cross sectional area than a hose connected to said device to deliver to said device a dry particulate under pressure to be preformed into said slurry, a diverging passage extending from said inlet and a transition passage located downstream of said diverging passage, said transition passage having a substantially constant cross section, and a liquid inlet being located in one said diverging passage or said transition passage.

The mixing device can be formed from liners which respectively include the diverging transition and converging passages.

The inlet end of the diverging passage has a flange to allow said inlet end to connect to a hose by a coupling device.

The device can include an a converging passage whereby the outlet end of the converging passage has a flange to allow connection to a conduit by a coupling device.

The liners can be manufactured from a polymeric material. The liners can be mounted within a generally cylindrical jacket and compressed into communication with each other to carry said mixture. The liners can be manufactured from metals such as stainless steel, mild steel, brass, or polymeric materials such as urethane, nylon and others.

The mixing device can include one or more of the features described above which are attributable to a mixing device as described in paragraphs [0004] to [0025] above

### BRIEF DESCRIPTION OF THE DRAWINGS

An embodiment of the present invention, will now be described by way of example only, with reference to the accompanying drawings in which:

FIG. 1 is a schematic of the components of an installation system embodying the invention for the application of refractories by a gunning method;

FIG. 2 illustrates a diverging passage liner and casing;

FIG. 3 illustrates a transition passage liner and casing;

FIG. 4 illustrates a converging passage liner and casing;

FIG. 5 illustrates the casings of FIGS. 2 to 4 assembled into a mixing device;

FIG. 6 illustrates a pump flow schematic diagram and

FIG. 7 illustrates a mixing device similar to that of FIG. 5 with additional components;

FIG. 8 illustrates another view of the diverging passage casing with a nozzle therein;

FIG. 9 illustrates a view of the transition passage casing of FIG. 3 with a nozzle associated therewith;

FIG. 10 illustrates a schematic showing the height and conduit length limitations on the system;

FIG. 11 is a representation of a nozzle such as those described at paragraph [0068] to [0070];

FIG. 12 illustrates a nozzle assembly which can be used with the system of FIG. 1;

FIG. 13 illustrates another nozzle assembly which can be used with the system of FIG. 1; and

FIG. 14 illustrates a modified transition liner which can be used in replacement of the liner of FIG. 3

### DETAILED DESCRIPTION OF THE DRAWINGS

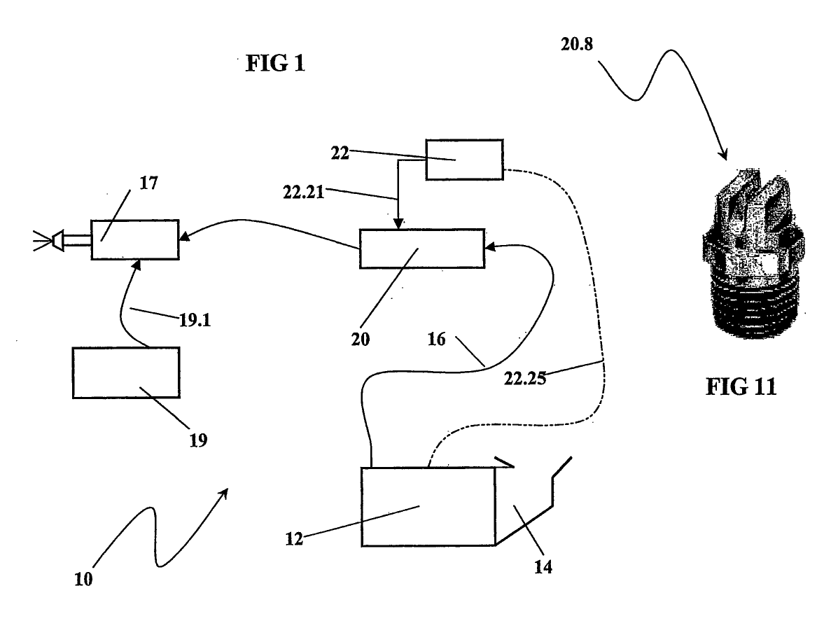

Illustrated in FIG. 1 is a refractory installation system 10 for spraying a refractory liner slurry onto a furnace wall or components. The system 10 includes a gun device 12 such as the LOVA™ brand of gun manufactured by REED® having some 20 or 21 pockets or the SOVA™ brand of gun, also manufactured by REED® having an 16 pocket feed wheel, however over other rotary guns are suitable.

The gun 12 has a gun hopper 14 into which a dry particulate material, which will form the slurry, can be fed. In the following description the dry particulate material will be for use as a refractory lining, but it will be appreciated that other dry particulate such as cement or other appropriate material can be used.

The dry particulate material is fed by the gun 12 into a feed conduit 16 so as to be delivered to a preform mixer 20 where the dry particulate is mixed with a liquid from a pump system 22. The liquid can include such things as water; aqueous solutions such as those including a surfactant or colloidal silica solution; or a solution having a setting accelerator for the slurry. The pump system 22 delivers the liquid under pressure to the preform mixer 20 so as to form a “slurry preform”, which may also be described as a product preform. At this stage, the product preform cannot be described as a “slurry” per se as there is in the product preform more dry particulate than liquid.

The product preform being a mixture of the liquid and dry particulate, allows the product preform to begin the setting process. However, the final liquid content of the slurry to be ejected from the nozzle 17 is achieved or determined by the amount of water or other liquid added to the product preform at the nozzle 17.

Thus the product preform mixture exits the mixing device 20 where it progresses along a second feed conduit 18 to a standard delivery nozzle 17. At the nozzle 17, if a wet slurry is being pumped and ejected from the system 10, there is added water from a mains water supply 19 (or water or other liquid can be added from a pump) which would be ordinarily used to add the final amount of liquid to form the slurry, so that it is completely formed as it exits the nozzle 17.

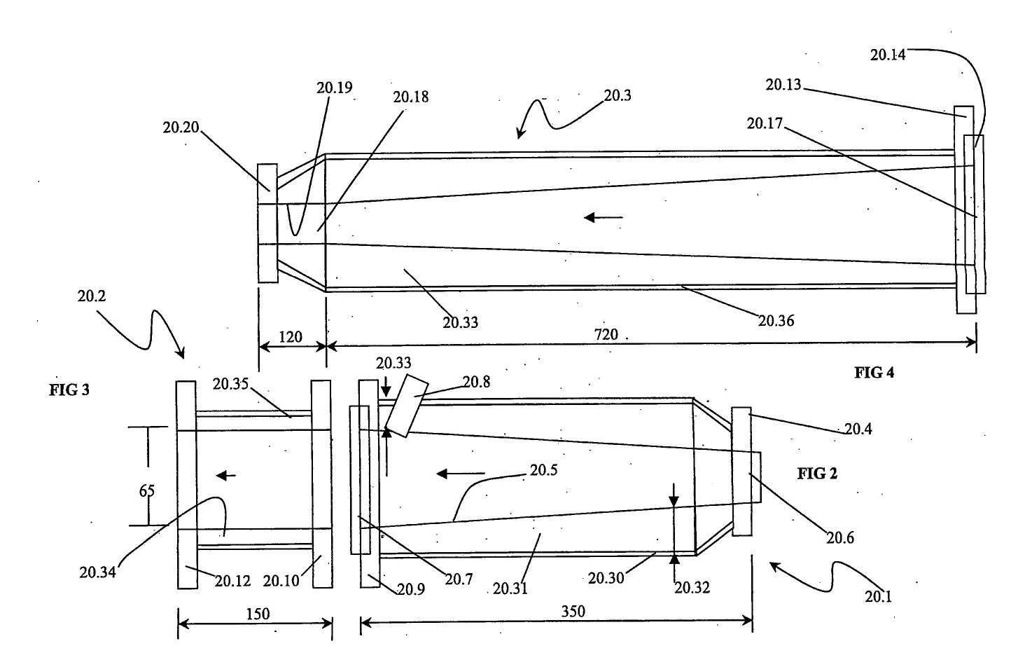

Illustrated in FIGS. 2 to 4 are the components of the preform mixer 20 which are also shown as an assembly in FIG. 5. The preform mixer 20 is made up of an inlet segment 20.1, which can be broadly described as having an expansion chamber therein; a central transition segment 20.2 which has a settling chamber therein; and an outlet segment 20.3 which can be broadly described as having a compression chamber therein. The inlet segment 20.1 is made from a liner 20.31 and a casing 20.30; the transition segment 20.2 is made from a liner 20.34 and a casing 20.35; and the outlet segment 20.3 is made from a liner 20.33 and a casing 20.36, as will be described in more detail below.

As can be seen from FIG. 2, casing 20.30 of the inlet segment 20.1 has a standard REED® brand threaded hose end 20.4, so that a standard 38 mm inside diameter hose, which makes up the feed conduit 16 from the gun to the preformed mixer 20, can be connected to the inlet segment 20.1.

It will be noted that the liner 20.31 of inlet segment 20.1 has a divergent passage 20.5 which forms the expansion chamber. The passage 20.5 starts at the inlet 20.6 with an inside diameter of 50 mm and diverges or tapers at a generally constant rate to the maximum diameter of 65 mm at the outlet 20.7.

A 50 mm inside diameter inlet 20.6 is provided to ensure that the flow of dry particulate into the inlet 20.6 slows down by the increase in cross sectional area from the hose which has a 38 mm diameter to the inlet segment 20.1 which has a 50 mm diameter.

Near to the downstream end of the inlet segment 20.1 is an inlet nozzle 20.8 which passes through both the casing 20.30 and the liner 20.31. The nozzle 20.8 is mounted in a housing which is welded or otherwise joined to the casing 20.30. As can be seen in FIG. 5 the nozzle mounting and thus the nozzle 20.8 makes an angle of approximately 75° to the longitudinal axis of the preform mixer 20 (or the direction of flow through the mixer 20). The nozzle 20.8 allows a liquid (such as water) to be injected under pressure into the dry particulate flow stream passing through the diverging passage 20.5.

The outlet or downstream end of the casing 20.30 includes a flange 20.9 which will allow the inlet segment 20.1 to be bolted or joined by quick release clamping systems or the like, to the transitional segment 20.2 by a similarly shaped flange 20.10 on the casing 20.35.

While the inside diameter inlet 20.6 of the liner 20.31 is 50 mm and is for use with respect to a 38 mm hose, this inside diameter 20.6 could be of a magnitude which ranges from about 40 mm (approximately 5% greater than a hose's 38 mm diameter inside cross sectional area) up to approximately 80 mm. Even though an increase in the cross sectional area, being indicated in the increase from diameter 38 mm of the conduit 16 up to an 80 mm inside diameter for the inlet, would seem like a large increase, such a large increase will have little effect on the slowing down of the flow as secondary flows and cyclonic currents will form effectively reducing the diameter from 80 mm to a smaller dimension. The length of the inlet segment 20.1 is approximately 350 mm.

It will be noted from FIG. 3 that the transition segment 20.2 has its liner 20.34 comprised of a cylindrical passage 20.11 passing through it. The passage 20.11 is substantially constant in cross section. the transitional segment 20.2 is of a length of approximately 150 mm

The transition segment 20.2 terminates in a bolting flange 20.12 which allows for connection to the bolting flange 20.13 of the outlet segment 20.3 by any means such as bolts or quick release clamps or such like.

Ordinarily, between the flanges 20.13 and 20.12 or 20.10 and 20.9 an annular gasket or O-ring seal would be provided. However as the liners 20.31, 20.34 and 20.33 are manufactured from urethane or other appropriate polymeric material, once the flanges 20.13, 20.12, 20.10 and 20.9 have been respectively bolted or clamped together, there the compressive forces on the respective ends of the liners form an effective seal, obviating the need for gasket or other sealing materials. However, if the liners were manufactured from metal, such seals, gaskets, or sealing compounds may be required.

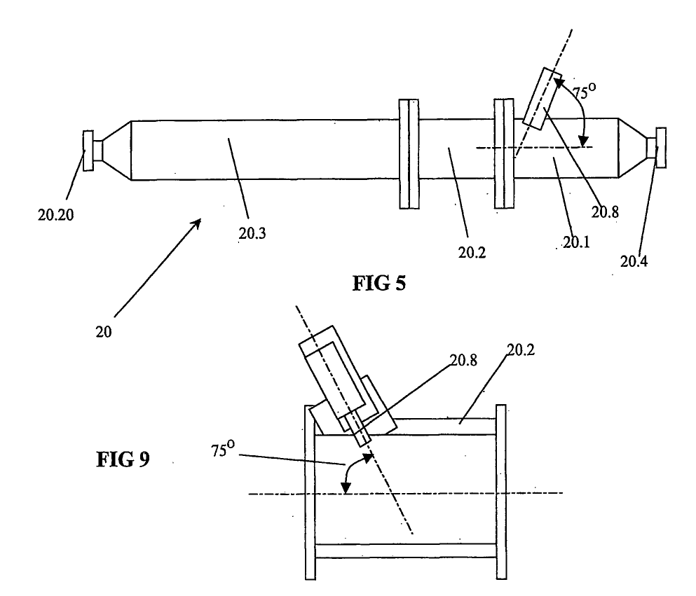

The outlet segment 20.3, as illustrated in FIG. 4 has a liner 20.33 which has a compression chamber therein formed by a converging passage 20.16 which tapers from an inlet 20.17 having an inside diameter of 65 mm to a minimum of 38 mm at the outlet 20.18.

It will be noted that the liner 20.33 and outlet segment 20.3 has a substantially constant cross section outlet passage 20.19 which proceeds to the terminus of the outlet segment 20.3.

The outlet segment 20.3 has its casing 20.36 terminating in a REED® brand mounting flange 20.20 for connecting, by means of a quick coupling system, to the feed conduit 18 of FIG. 1.

The thickness of the liners, such as the liner 20.31 varies from a maximum at 20.32 of approximately 20 mm to a lesser thickness in the region of 20.33 of approximately 10 to 12 mm.

The outer cylindrical or tubular steel casings 20.30, 20.35 and 20.36, help to provide strength to the liners which might be manufactured from such materials as urethane, nylon or other appropriate polymeric material. The liner could also be manufactured from brass or from steel or the whole inlet segment 20.1, transition segment 20.2 and outlet segment 20.3 manufactured from a single piece of metal.

The outlet passage 20.19, which is of constant cross section, on the outlet segment 20.3 extends for approximately 120 mm. Whereas the tapered nature of the passage 20.16 is such that the taper occurs over a distance of approximately 720 mm.

Whilst a dimension of 720 mm is indicated as the length of the taper for the compression chamber formed by the passage 20.16, this length could vary from 350 mm to 1500 mm, depending on the application and slurry being installed.

Similarly the expansion chamber formed by the passage 20.5 has its length indicated as being approximately 350 mm, however this could vary between 200 mm and 600 mm depending on the application.

The interaction of the flow of a liquid from the injection nozzle 20.8 and the flow of dry particulates passing through the diverging passage 20.5, is such that near to the end of the diverging passage 20.5 and in the passage 20.11 there are formed vortices or cyclones which aid in the mixing of the a liquid from the nozzle 20.8 with the dry particulates being forced through the mixing device 20 under pressure.

Further, as the dry particulate passes through the preform mixer 20 and water is injected from nozzle 20.8, it causes fine particles to coagulate and then to attach themselves to larger particles which are thought to cause the product to form small moist spheres. This aids in the conveyance of the product to the target area and adds compressive dwell time which is greater than in conventional systems which do not employ the preform mixer 20. As the product travels along the line 18, it continues to pelletise and dwell. This helps to reduce dust and rebound without reducing the control that the nozzle 17's operator has on the final wet up or water additions at the nozzle 17.

The nozzle 20.8 as mentioned in FIG. 1 receives a liquid at a high pressure from the pump 22. The nozzle 20.8 is preferably of a type manufactured by Spray Systems Company Pty Ltd of Australia and they have three nozzles which are suitable for a variety of applications Thus the following nozzles have been found to be useful in the following applications:

BH1/4VV-SS11003 Nozzle specifications:
This nozzles operates at 0.3 US gallons per minute with a spray angle of approximately 110° both at an operating pressure of 40 psi. This nozzle is suitable for low cement, standard high, gun materials.
Other uses for the nozzles include cooling and quenching, product washing, water cooling, air and gas washers, scrubbers, liquor washers, dust control, fire protection.
This nozzle is a standard VeeJet spray nozzle featuring a high impact solid stream or flat spray pattern with spray angles of 0° to 110° at 40 psi (3 bar). It produces a uniform distribution of small to medium-sized drops. It provides specially tapered spray pattern edges which provide even spray coverage when several nozzles with over-lapping patterns are required. This nozzles features flow rates below 1 gpm at 40 psi (3.9 l/min at 3 bar).
Nozzle Inlet Connection: Male BSPT.
Spray Angle at 40 psi (degrees): 110.
Spray Pattern Type at 40 psi (degrees): Tapered Edge.
Capacity (gallons per minute) at 40 psi: 0.3.
Nozzle Type H-VV Inlet Connection (inches): ¼.
Capacity Size: 03.
Material: 303 Stainless Steel.
Material Code: SS.
Length (inches): 29/32
Hex (inches): 9/16.
Net Weight (oz): ¾.
Option Integral Strainer Minimum PSI: 5.
Maximum PSI: 500.
Accessories: Split-eyelet Connector, Pressure Gauges, Adjustable Ball Fittings, Pressure Relief Valves, Strainers, Control Valves, Check Valves Swivel Connectors.

BH1/4VV-SS110015 nozzle specifications:
operates at 0.15 US gallons per minute with a spray angle of 110° both at an operating pressure of 40 psi and is suitable for conventional gun materials.
Capacity (gallons per minute) @ 40 psi: 0.15
Capacity Size: 15
All other specifications are the same as for BH1/4VV-SS11003 mentioned in paragraph [0070].

BH1/4VV-SS8003 nozzle specifications:
has an 80° cone angle from the nozzle with a 0.3 US gallons per minute both measured at a flow rate of 40 psi. Flow rate through this nozzle was suitable for silicon carbide and any gun mixes needing more material control,
Spray Angle at 40 psi (degrees): 80
Capacity (gallons per minute) @ 40 psi: 3
Capacity Size: 03
All other specifications are the same as for BH1/4VV-SS11003 mentioned in paragraph [0070].

The specifications for these nozzles are included above thereby allowing nozzles from other suppliers to be sourced or manufactured.

Whilst the above-described nozzle 20.8 passes through the casing 20.30 and is directed towards the centre line through the passage 20.5 and this does provide sufficient, cyclonical vortex mixing to occur, if desired the axial direction of the nozzle 20.8 and its mounting arrangement, can be skewed relative to the central axis of the passage 20.5 to possibly provide a greater amount of vortex or cyclonic motion and thus possibly better mixing.

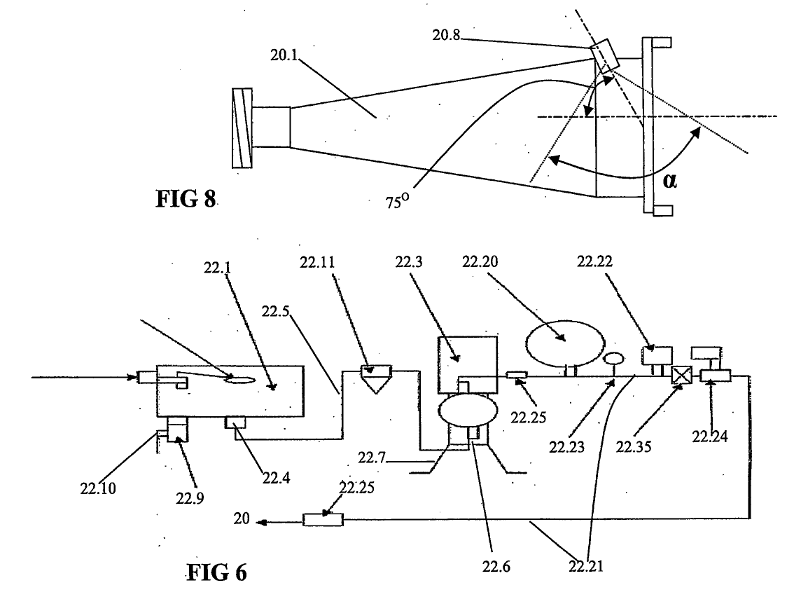

Illustrated in FIG. 6, is a more detailed schematic of the pump system 22, which is generally designated as such in FIG. 1, has a tank 22.1 which can be mounted on a support frame (not illustrated), which provides liquid to be passed into the pumping unit which is a displacement pump 22.3. At the bottom of the tank 20 is a liquid outlet 22.4 which is connected by a conduit 22.5 to the inlet 22.6 of the pump 22.3.

The pump 22.3 is on a stand 22.7. To enable transportation of the pump system 22, a drain valve 22.9 is provided with a manually operated valve member 22.10 so that the tank can be emptied as desired.

A liquid filter 22.11 is also provided in the line 22.5 so that liquid from the tank 22.1 can be filtered prior to entry at the inlet 22.6 of the pump 22.3.

The pump system 22 also includes a pressure tank 22.20 on an outlet line 22.21 which also includes a pressure switch 22.22, a pressure gauge 22.23 and a ball valve 22.35. The ball valve 22.35 prevents water pressure from flowing back to the pump 22.3 from the pressure tank 22.20. The pressure tank 22.20 allows the pump 22.3 to build pressure against the head of air in the tank 22.20. This in turn allows a high injection pressure to be achieved. The pressure switch 22.22 is adjusted so as to sense that the pump 22.3 has reached its maximum pressure and it then turns off the power to the pump 22.3, however this is only possible when the flow of water is stopped at the discharge valve. The pressure gauge 22.23 indicates the pressure that is contained in the pump system 22. An air poppet valve 22.24 and a check valve 22.25 can also be provided on the outlet line 22.21 which directs the liquid under pressure to the nozzle 20.8 of FIGS. 2 and 5.

The air poppet valve 22.24 is connected with the gun 12 so that when the operator of the gun 12 starts to provide dry particulate under pressure into the conduit 16, the air poppet valve 22.24 by virtue of the increase pressure in the line 22.25 connecting the poppet valve to the gun 12, will cause the poppet valve to open thus allowing liquid to now flow along conduit 22.21 to the preform mixer 20 and out of nozzle 20.8. With the system 10, the nozzle operator works together with the gun operator to control the flow through the system. While this could be automated, it is expected that better results should be able to be obtained by a manual system.

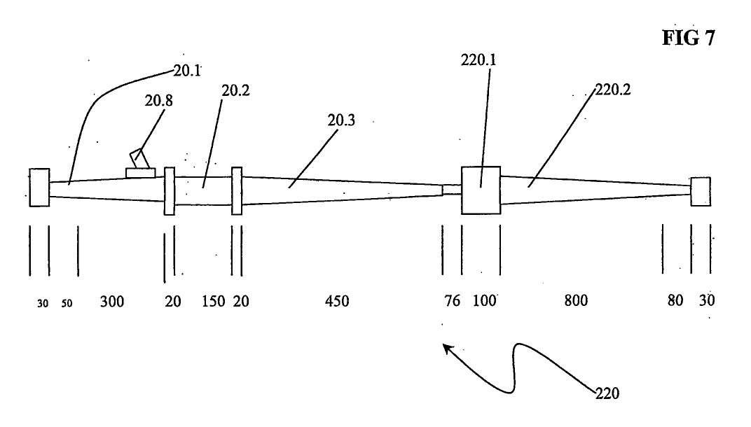

Illustrated in FIG. 7 is a preform mixing system 220 which has an inlet segment 20.1, transition segment 20.2 and outlet segment 20.3 which are the same as the corresponding units on the mixer 20 of FIGS. 2 to 5. However, in addition to the mixing unit system 220 also includes a pelletising chamber 220.1 and a second compression chamber 220.2 of approximately 100 mm and 800 mm respectively in length. The pelletising chamber 20.2 can be useful in some circumstances so as to ensure complete mixing for harder to mix products such as concrete and the like.

Illustrated in FIG. 8 is the expansion chamber of the inlet segment 20.1 showing the nozzle 20.8 and the spread of the spray jet coverage from that nozzle 20.8 whereby the angle α represents an angle of the spray from the nozzle 20.8 of between 80° and 100°.

Illustrated in FIG. 9 is the transition segment 20.2 which can, as an alternative, include the nozzle 20.8 therein. This has been found to be effective but not as effective as when the nozzle 20.8 is mounted near the end of the expansion chamber. As the rate of flow of the dry particulate at the end of the expansion chamber is approximately the same as that in the transition segment 20.2, the end of the expansion chamber is the first opportunity to inject the liquid spray with the dry particulate travelling at its slowest.

The liners 20.33, 20.31 and 20.34 can be made from urethane or approximately 90 dent or any appropriate material—rubber, nylon, other synthetic materials could also be expected to be satisfactory but at this time have not been tried.

The pump system 22 operates at approximately 1000 kPa whilst the feed gun 12 might operate between a minimum pressure of around 100 kPa (such as for light weight dry particulates such as insulation compounds) and a maximum pressure of around 600 kPa (such as for heavy or dense castables). During operation of the system of FIG. 1, a pressure of the order of 100 kPa to 200 kPa and more preferably 120 kPa to 160 kPa is measured in the conduit 18 feeding the nozzle 17, at a location approximately 1 metre to 2 metres back from the nozzle 17. It is the differential in pressure between these two units which allows for the liquid ejected from the nozzle 20.8 to enter into the stream of the dry particulate material from the feed gun 12.

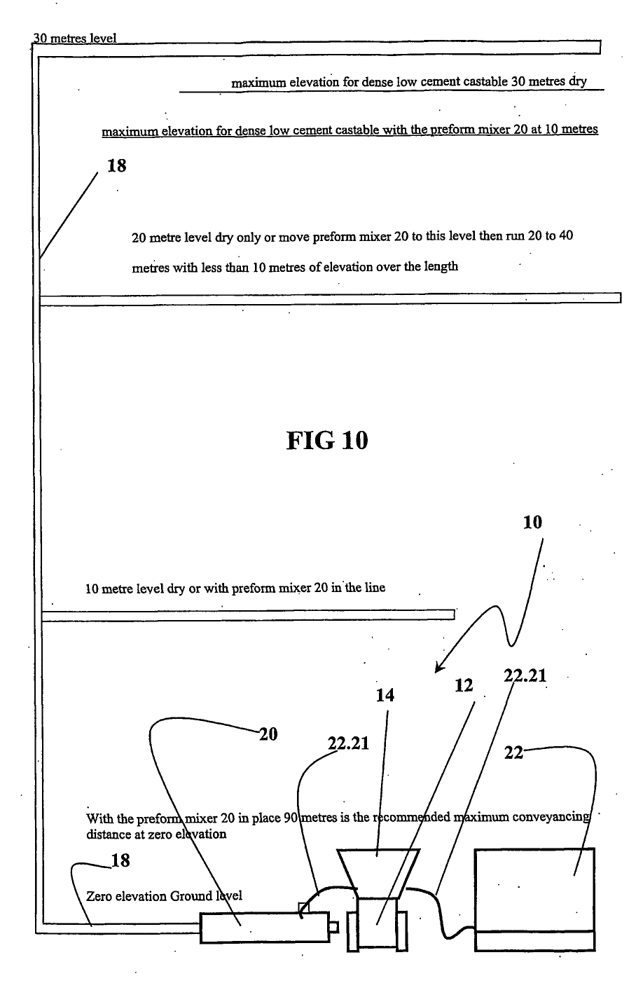

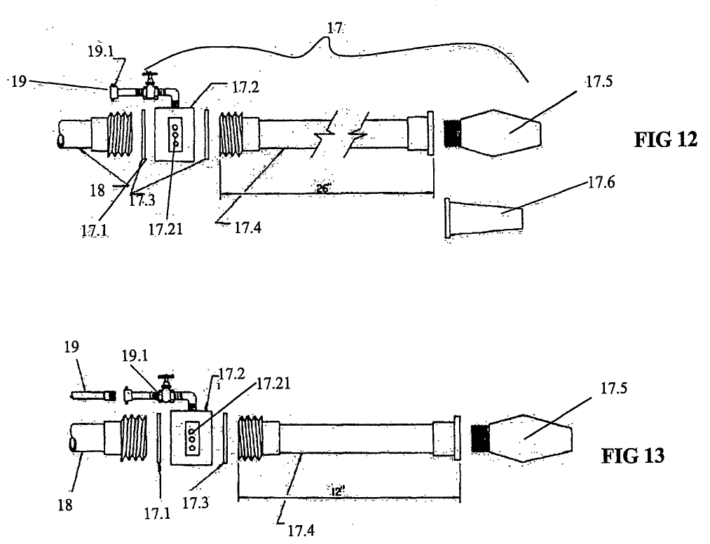

As is illustrated in FIG. 10, there are some height and distance limitations to the above described system, based on a feed hose diameter of 38 mm and a mixing device 20 for use there with.

In the table below is a summary of the expected limitations:

| | Distance from | Distance from |
|---|---|---|
| Location of Gun, | Gun to Mixer | Mixer to Nozzle |
| Mixer, Nozzle | (Conduit distance | (Conduit distance |
| (Height in metres) | in metres) | in metres) |
| All at same level | 10 | 90 |
| (to within 1 | | |
| to 2 metres) | | |
| 10 metres above Gun | 10-12 | 20 to 40 |
| 20 metres above Gun | 20 | 20 |

It is desirable to ensure that the minimum distance from the mixing device 20 to the nozzle 17 is, in most applications, no less than 20 metres. This distance allows dwell time of the product preform to be at its most desirable. Likewise, a distance greater than 90 metres may make the dwell time too great. These dimensions are of course dependent upon whether setting accelerators or inhibitors are utilised.

While the above description and mixing device 20 is exemplified relative to 38 mm diameter feed hoses, the mixing device 20 having the dimensions discussed above will be suitable for 20 mm and 32 mm standard size hoses as well. However, to increase to a standard size hose of 50 mm, 55 mm or 65 mm, a mixing device 20 having generally larger dimensions will be required for effective operation thereof.

The gun 12 preferably utilises dehumidified air to allow the product being installed to impact the target area with sufficient force to pack the product. A 600 cubic feet per minute compressor will be suitable for installations at or just above ground level.

During operation and due to mixing which takes place in the preform mixer 20, should the gunning be stopped for more than 10 to 15 minutes, then the liners 20.31, 20.34 and 20.33 of the preform mixer 20 should be cleaned. It should be noted that the feed hose 18 could be caused to block if excessive water is injected from nozzle 20.8 into the preform mixer 20.

It is preferable that the liners 20.31, 20.34 and 20.33 be cleaned if the elevation at which gunning takes place has to be altered. This is due to the fact that the preform mixer 20, will find an equilibrium condition when it is used at a first elevation. The equilibrium condition is that condition whereby those portions of the preform mixer 20, due to eddy currents and setting of the particulate, will have the passages somewhat lessened in cross sectional area or modified due to product which may have set, by comparison to the unobstructed passages through the liners 20.31, 20.34 and 20.33 at the start of gunning. To ten change the elevation at which gunning will occur will provide additional set product building up on the previously set product thereby risking a blockage. Whereas, by first cleaning the liners 20.31, 20.34 and 20.33 of the preform mixer, and then changing the elevation, ensures for that elevation an equilibrium condition will be achieved

When utilising the systems above it is best that the gun 12 be as close to the work area as possible. The gun 12 and preform mixer 20 are preferably located so that the feed hose 16 forms as straight a connection as possible between the two.

The water used in the above described system needs to be of the highest grade possible, and clean drinking water will be of suitable grade. Hoses should be in good order and condition and be arranged so that the most worn hose is used at the gun 22 end and the least worn at the nozzle 17 end. This keeps the product moving at the same, or slightly higher velocity, hence reducing the chance for wet fines from adhering to the inside of the hose.

The nozzle 17 can have a water body such as holeless water ring system. Whilst it is possible to use a standard hole water ring and body, due to the variation in the number and the size of holes it becomes difficult to achieve and maintain the optimum injection velocity.

As an example of the water ring system, the Allentown company produces a standard water body and water ring configuration, called the HYDRO-MIX nozzle, which is for dense castable and is illustrated in FIG. 12. The nozzle 17 assembly of FIG. 12 shows the terminus of the hose 18 which connects to the nozzle assembly 17 via a water body 17.2 which has a water ring 17.21 therein. The water ring 17.21 has eight 1/16″ holes to eject water therefrom into the material passing through the water body 17.2. The water body 17.2 connects to the hose 18 via a rubber washer 18 and to a material hose 17.4 also via a rubber washer 11.3 and a screw fitting. The water body 17.2 is connected by a hose 19.1 to mains water supply 19. The material hose 17.4 is approximately 650 mm in length and terminates with a female threaded end to receive either a Hamm tip 17.5 which also has a liner or a tapered tip 17.6 which also has a liner.

Another alternative for the nozzle 17 is to use a nozzle assembly known in the industry as a double bubble nozzle or sprayer.

Illustrated in FIG. 13 is another HYDRO-MIX nozzle which is similar to that of FIG. 12 and like parts have been like numbered. The nozzle 17 assembly in FIG. 13 is used for insulating castables and has a water ring 17.21 with sixteen 1/16″ holes. The reason for the larger number of holes is that insulating castables require more water than dense or conventional castables and it is important that the flow of water through these holes is at the highest velocity possible based on the amount of water required.

The surface area of the sixteen hole water ring 17.21 of FIG. 13 does not provide sufficient velocity to penetrate a dense castable properly and hence poor mixing is achieved. For the same tap opening with an eight hole ring, the total volume is the same but the velocity is markedly higher and hence penetration and mixing of the product is improved. It is for this reason that, when gunning high technology-low cement products, a holeless water ring system is recommended to be used. It provides a reduced surface area for the water to be injected at the reduced volume requirement for low cement products and at the same time provides the best possible injection velocity.

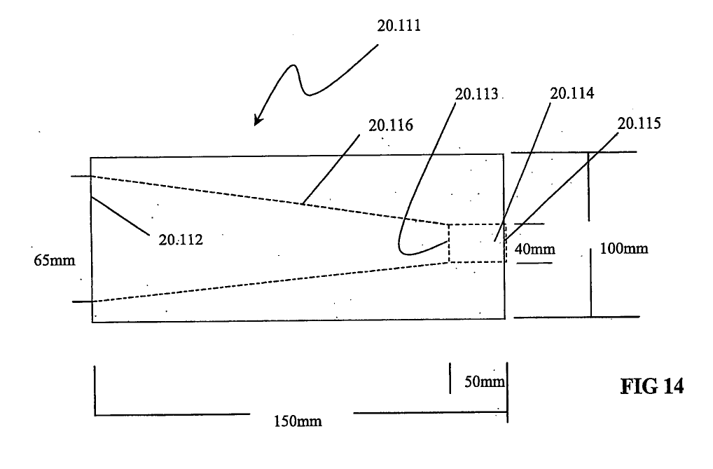

Illustrated in FIG. 14 is a liner 20.111 which can be used with fine refractory products and is preferred to the liner 20.34, which is better suited to course refractory products and civil concrete products. The liner 20.111 is sized to be used within the transition segment 20.2 of FIG. 3. The liner 20.111 has an inlet 20.112 having an inlet diameter of 65 mm. The inlet 20.112 opens into a tapering passage 20.116 which tapers down along a 100 mm to the start 20.113 of an 50 mm long outlet passage 20.114 of 40 mm in diameter. The outlet passage 20.114 has a cylindrical construction and terminates at outlet 20.115. The outlet 20.115 when assembled adjacent an outlet segment 20.3 provides an expansion path from the 40 mm diameter to the 65 mm diameter of the inlet 20.17 of outlet segment 20.3

The liner 20.111 has been found to be beneficial for several reasons, a first being that it reduces the amount of cleaning that would be required by comparison to the liner 20.34. This is due to some of the partially mixed particulate setting in the liner 20.34 when in use. Another reason is that the diverging nature of the liner 20.111 allows additional compressive dwell when it is used with fine refractory products.

It will be understood that the invention disclosed and defined herein extends to all alternative combinations of two or more of the individual features mentioned or evident from the text. All of these different combinations constitute various alternative aspects of the invention.

The foregoing describes embodiments of the present invention and modifications, obvious to those skilled in the art can be made thereto, without departing from the scope of the present invention.

1. A slurry spraying or installation system including a gun means, a spray nozzle and a conduit connecting said gun means to said spray nozzle, said gun means including a pump means to move dry particulate towards said nozzle along said conduit, wherein between said gun means and said nozzle is a mixing device which receives said dry particulate and mixes same with liquid under a greater pressure than the pressure that said dry particulate is under, so as to form a liquid and dry particulate mixture; said mixture being fed to said nozzle for dispensing to a target.

2. A system as claimed in claim 1, wherein said mixing device includes an expansion chamber having a diverging passage which diverges in the direction of flow of said dry particulate.

3. A system as claimed in claim 2, wherein said mixing device includes, downstream of said diverging passage, a transition passage.

4. A system as claimed in claim 3, wherein at least one of said diverging passage or said transition passage, or between these passages, there is included a liquid inlet.

5. A system as claimed in claim 4, wherein said liquid inlet includes a liquid inlet nozzle which projects liquid at an angle to the direction of flow of said dry particulate through said mixing device.

6. A system as claimed in claim 4, wherein said liquid inlet nozzle can be at an angle of between 40° and 80° from the direction of flow.

7. A system as claimed in claim 5, wherein said nozzle is aligned so that a central longitudinal axis thereof intersects a central longitudinal axis of said mixing device.

8. A system as claimed in claim 5, wherein said nozzle is aligned so that a central longitudinal axis thereof is skewed relative to a central longitudinal axis of said mixing device.

9. A system as claimed in claim 1, where said mixing device includes a converging passage downstream of said transition passage.

10. A system as claimed in claim 1, wherein an inlet to the diverging passage is of a larger cross sectional area than the cross sectional area of the end of a conduit delivering said dry particulate from said gun means to said mixing device.

11. A system as claimed in claim 1, wherein said inlet to the diverging passage has a diameter in the range from 5% to 200% larger than the internal diameter of a conduit delivering dry particulate to said diverging passage.

12. A system as claimed in claim 10 wherein said conduit has an internal diameter of approximately 38 mm and said inlet diameter of said diverging passage is in the range of 40 to 60 mm and possibly up to 80 mm.

13. A system as claimed in claim 1, wherein the inside diameter of said diverging passage at the end of said passage is of the order of 55 mm to 80 mm.

14. A system as claimed in claim 1, wherein a preferred set of dimensions for the diverging passage includes: the inlet is 50 mm and the end of the passage expands out to 65 mm for a 38 mm inside diameter conduit delivering dry particulate to said diverging passage.

15. A system as claimed in claim 1, wherein said diverging passage can be of a length which varies from 150 mm to 900 mm.

16. A system as claimed in claim 1, wherein said transition passage can have the same cross sectional area or internal diameter as the outlet end of the diverging passage.

17. A system as claimed in claim 16, wherein said transition passage extends for a distance of between 100 mm and 300 mm

18. A system as claimed in claim 1, wherein said transition passage has a substantially constant cross section.

19. A system as claimed in claim 1, wherein said transition passage has a converging shape.

20. A system as claimed in claim 1, wherein said converging passage and or said transition passage terminates in an outlet passage of substantially constant cross section.

21. A system as claimed in claim 20, wherein said outlet of said converging passage has a cross sectional area which is approximately equal to the cross sectional area of the passage in a conduit to be connected to said outlet.

22. A system as claimed in claim 20, wherein said converging passage has its largest diameter in the order of 60 mm to 80 mm and it tapers down to 38 mm at its outlet diameter.

23. A system as claimed in claim 22, wherein the length of the taper can vary between 350 mm and 1500 mm, but preferably between 600 mm to 800 mm and most preferably around 720 mm.

24. A system as claimed in claim 20, wherein said outlet passage of said converging passage which is of substantially constant cross section can extend for between 80 mm and 200 mm and more preferably 120 mm.

25. A system as claimed in claim 1, wherein the liquid inlet can be a liquid ring.

26. A system as claimed in claim 1, wherein when the gun means, the nozzle during use, and the mixing device are within a height differential of between up to 1 metre to 2 metres of each other, the mixing device is located along a conduit length of no more than 90 metres from the nozzle.

27. A system as claimed in claim 1, wherein said mixing device is in the range of 5 m to 15 m of conduit length from the gun means.

28. A system as claimed in claim 1, wherein said gun means preferably applies a pressure of between lOOkpa and 600 kpa to the dry particulate.

29. A system as claimed in claim 1, wherein said liquid inlet to the mixing device has its own supply and pressure source.

30. A system as claimed in claim 29, wherein said pressure source can supply liquid to the liquid inlet at approximately 1000 kPa.

31. A system as claimed in claim 29, wherein the pressure source can supply enough pressure to provide a pressure differential between the liquid inlet pressure and the dry particulate pressure of the order of 200 kPa to 900 kPa.

32. A system as claimed in claim 1, wherein the liquid inlet nozzle propels liquid in a spray having a spray angle in the order of 70° to 120° with a flow rate of between 0.1 US gallon per minute to 0.4 US gallons per minute.

33. A system as claimed in claim 1, wherein the system develops a pressure of the order of 100 kPa to 200 kPa, when measured in the conduit feeding the nozzle, at a location approximately 1 metre to 2 metres back from the nozzle.

34. A system as claimed in claim 1, wherein said system includes the ability to add liquid to the preform slurry at said nozzle prior to ejection or emission from said nozzle.

35. A mixing device to preform a settable slurry, said device including an inlet having a larger internal cross sectional area than a hose connected to said device to deliver to said device a dry particulate under pressure to be preformed into said slurry, a diverging passage extending from said inlet and a transition passage located downstream of said diverging passage, said transition passage having a substantially constant cross section, and a liquid inlet being located in one said diverging passage or said transition passage.

36. A mixing device as claimed in claim 35, wherein said mixing device is formed from liners which respectively include the diverging passage, transition passage and converging passage.

37. A mixing device as claimed in claim 35, wherein said inlet end of the diverging passage has a flange or other fitting to allow said inlet end to connect to a hose by a coupling device.

38. A mixing device as claimed in in claim 35, wherein there is included a converging passage whereby the outlet end of the converging passage has a flange or other fitting to allow connection to a conduit by a coupling device.

39. A mixing device as claimed in claim 35, wherein said transition passage is of a substantially constant cross section.

40. A mixing device as claimed in claim 35, wherein said transition passage is of a converging shape.
